(19) United States
(12) Patent Application Publication
(10) Pub. No.: US 2025/0291130 A1
(43) Pub. Date: Sep. 18, 2025

(54) METHOD AND SYSTEM FOR COUPLING OF OPTICAL FIBERS TO SILICON PHOTONIC DEVICES

(71) Applicant: RAM Photonics Industrial, LLC, Webster, NY (US)

(72) Inventor: John R. Marciante, Webster, NY (US)

(73) Assignee: RAM Photonics Industrial, LLC, Webster, NY (US)

(21) Appl. No.: 19/076,838

(22) Filed: Mar. 11, 2025

Related U.S. Application Data
(60) Provisional application No. 63/564,327, filed on Mar. 12, 2024.

(51) Int. Cl. G02B 6/42

(52) U.S. Cl. CPC G02B 6/4214; G02B 6/423

(57) ABSTRACT

A system comprising a plurality of optical fibers and a first microlens array including a plurality of microlenses. Each of the plurality of optical fibers is bonded to one of the plurality of microlenses. The system also includes a prism disposed adjacent the first microlens array, a second microlens array disposed adjacent the prism, and a silicon photonics substrate disposed adjacent the second microlens array and including a plurality of input coupling elements and one or more optical waveguides.

### CROSS-REFERENCES TO RELATED APPLICATIONS

This application claims priority to U.S. Provisional Patent Application No. 63/564,327, filed on Mar. 12, 2024, entitled “METHOD AND SYSTEM FOR COUPLING OF OPTICAL FIBERS TO SILICON PHOTONICS DEVICES,” the disclosure of which is hereby incorporated by reference in its entirety for all purposes.

### BACKGROUND OF THE INVENTION

Silicon photonics is an emerging area of optical technology that is useful in optical telecommunications, optical information processing, and integrated manufacturing. Wavelength division multiplexing (WDM) systems have enable 40-Gbit/s and 100-Gbit/s data rates in optical communication systems. In order to increase system bandwidth, optical components can be integrated on silicon substrates (e.g., silicon-on-insulator (SOI) substrates) in order to fabricate large-scale photonic integrated circuits that include one or more of a wide variety of micro-electronic devices and photonic components, including optical filters, multiplexers, demultiplexers, splitters, optical modulators, photodetectors, and the like.

Although significant development has been made in the area of silicon photonics, there is a need in the art for improved methods and systems to coupling optical signals into and out of silicon-based substrates, including SOI substrates.

### SUMMARY OF THE INVENTION

Embodiments of the invention generally relate to the field of integrated optics. More specifically, embodiments of the present invention relate to optical couplers suitable for integration with silicon photonics devices. In a particular embodiment, a plurality of optical fibers are bonded to an optical coupler that directs light from each of the plurality of optical fibers to a corresponding input coupling element, for example, a diffraction grating, of a silicon photonics substrate. Light from each of the plurality of optical fibers is then able to propagate in an optical waveguide in the silicon photonics substrate. The invention has wider applicability, including other integrated optics applications.

As described more fully herein, systems and methods for coupling optical fibers to silicon photonic devices are provided. In particular, various embodiments are directed to an optical element, for example, a prism, having an input surface to which a plurality of optical fibers are welded (e.g., laser welded). The output of the optical element can be efficiently coupled to input coupling elements (e.g.,) grating couplers optical coupled to a silicon photonics chip. The light from the optical fibers can be directed onto the grating couplers, thereby producing outputs propagating in silicon photonic waveguides on a single chip. In some embodiments, light emitted from each optical fiber can be coupled into a corresponding waveguide associated with each optical fiber. In these embodiments utilizing a one-to-one match between a specific optical fiber and a matching waveguide, light can be coupled into each matching waveguide through a separate input coupling element, e.g., a separate diffraction grating.

The optical element can be designed to be amenable to mass production manufacturing techniques, allowing for optical elements and coupled systems to be produced at low cost.

Additionally, the optical element can support arrays of input optical fibers of various sizes, including, for example, two-dimensional arrays greater than or equal to 2×8 optical fibers (e.g., 16 fiber arrays, 30 fiber arrays, 50 fiber arrays, 100 fiber arrays, etc.) within a low physical profile, allowing coupling to silicon photonic devices having small physical dimensions. In other embodiments, the number of optical fibers included in the array of optical fibers varies as appropriate to the particular application and a linear array of optical fibers of arrays with differing numbers of optical fibers in the various rows and columns can be utilized as appropriate to the particular application.

Numerous benefits are achieved by way of the present invention over conventional techniques. For example, embodiments of the present invention provide methods and systems that enable mass manufacturing of optical systems utilizing optical fibers to provide input optical signals used by silicon photonics devices, referred to herein as silicon photonics substrates. Moreover, embodiments, of the provide one-to-one imaging from input optical fibers to optical waveguides present on the silicon photonics substrate. These and other embodiments of the invention along with many of its advantages and features are described in more detail in conjunction with the text below and attached figures.

### BRIEF DESCRIPTION OF THE DRAWINGS

FIG. 1 is a simplified cross-section diagram illustrating a silicon photonics substrate and a plurality of input optical fibers bonded to an optical coupler according to an embodiment of the present invention.

FIG. 2 is a simplified cross-section diagram illustrating a silicon photonics substrate and a plurality of input optical fibers bonded to a dual-surface optical coupler according to an embodiment of the present invention.

FIG. 3 is a simplified cross-section diagram illustrating a silicon photonics substrate and a plurality of input optical fibers bonded to a tri-surface optical coupler according to an embodiment of the present invention.

FIG. 4 is a simplified cross-section diagram illustrating a silicon photonics substrate and a plurality of input optical fibers bonded to an optical coupler including a microlens array according to an embodiment of the present invention.

FIG. 5A is a simplified cross-section diagram illustrating a silicon photonics substrate, an optical coupler, and a fiberized microlens array according to an embodiment of the present invention.

FIG. 5B is a simplified cross-section diagram illustrating a silicon photonics substrate, an optical coupler, and a fiberized microlens array according to another embodiment of the present invention.

FIG. 6A is a simplified cross-section diagram illustrating a silicon photonics substrate, an optical prism, and dual microlens arrays according to an embodiment of the present invention.

FIG. 6B is a simplified cross-section diagram illustrating a silicon photonics substrate, an optical prism, and dual microlens arrays according to an embodiment of the present invention.

FIG. 7A is a simplified cross-section diagram illustrating a silicon photonics substrate, a plurality of input optical fibers, and dual microlens arrays mechanically coupled to a frame according to an embodiment of the present invention.

FIG. 7B is a simplified cross-section diagram illustrating a silicon photonics substrate, a plurality of input optical fibers, and dual microlens arrays mechanically coupled to a frame according to another embodiment of the present invention.

FIG. 8A is a simplified cross-section diagram illustrating a silicon photonics substrate and an Offner relay optical coupler according to an embodiment of the present invention.

FIG. 8B is a simplified plan view diagram illustrating the silicon photonics substrate and Offner relay optical coupler shown in FIG. 8A.

FIG. 8C is a simplified perspective view diagram illustrating the silicon photonics substrate and Offner relay optical coupler shown in FIG. 8A.

FIG. 9 is a simplified cross-section diagram illustrating a silicon photonics substrate, a plurality of input optical fibers, and an optical coupler including a microlens array according to an embodiment of the present invention.

FIG. 10A is a simplified cross-section diagram illustrating a silicon photonics substrate, a plurality of input optical fibers, and a spatially separated, fiberized microlens array according to an embodiment of the present invention.

FIG. 10B is a simplified cross-section diagram illustrating a silicon photonics substrate, a plurality of input optical fibers, and a spatially separated, fiberized microlens array according to another embodiment of the present invention.

FIG. 11A is a simplified cross-section diagram illustrating a silicon photonics substrate, a plurality of input optical fibers, and a fiberized optical coupler according to an embodiment of the present invention.

FIG. 11B is a simplified cross-section diagram illustrating a silicon photonics substrate, a plurality of input optical fibers, and a fiberized optical coupler according to another embodiment of the present invention.

FIG. 12 is a simplified plan view diagram illustrating a silicon photonics substrate, a plurality of input optical fibers, and a high density optical coupler according to an embodiment of the present invention.

### DETAILED DESCRIPTION OF SPECIFIC EMBODIMENTS

Embodiments of the invention generally relate to the field of integrated optics. More specifically, embodiments of the present invention relate to optical couplers suitable for integration with silicon photonics devices. In a particular embodiment, a plurality of optical fibers are bonded to an optical coupler that directs light from each of the plurality of optical fibers to a corresponding input coupling element, for example, a diffraction grating, of a silicon photonics substrate. Light from each of the plurality of optical fibers is then able to propagate in an optical waveguide in the silicon photonics substrate. The invention has wider applicability, including other integrated optics applications.

As described herein, some embodiments of the present invention provide a prism construct in which optical input signals for a silicon photonics substrate are provided by optical fibers that are laser welded to an optical coupler, also referred to as a beam redirector, that is able to efficiently couple the optical input signals into the silicon photonics substrate using input coupling elements, for example, diffraction gratings. Embodiments of the present invention provide high efficiency defined in terms of the optical intensity propagating in the optical waveguide of the silicon photonics substrate compared to the optical intensity propagating in the corresponding optical fiber as well as a high level of manufacturability. As a result, embodiments of the present invention are able to provide methods and systems that, from a perspective of mass manufacturing, provide high yield and low cost. In some embodiments, a molded glass optical element can be utilized or an optical element fabricated using magnetorheological finishing (MRF) techniques at wafer scale.

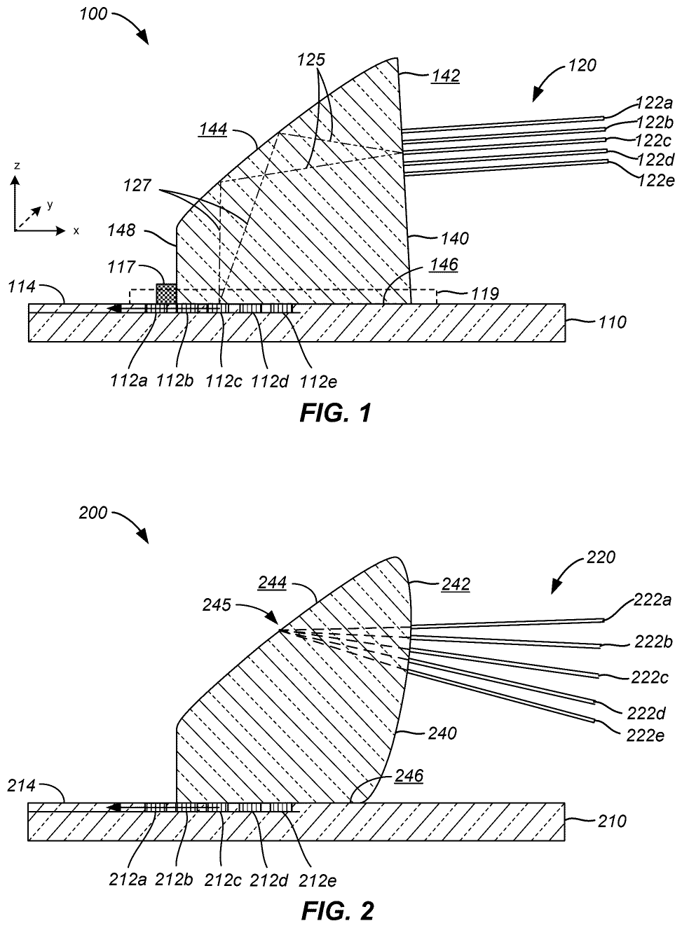

FIG. 1 is a simplified cross-section diagram illustrating a silicon photonics substrate and a plurality of input optical fibers bonded to an optical coupler according to an embodiment of the present invention. Referring to FIG. 1, system 100 includes a silicon photonics substrate 110 that includes input coupling elements 112a, 112b, 112c, 112d, and 112e as well as optical waveguides represented by optical waveguide 114. Other elements, including both active and passive devices, can be provided on the silicon photonics substrate 110 as will be evident to one of skill in the art.

Embodiments of the present invention, including the embodiment illustrated in FIG. 1 utilize a silicon photonics substrate 110 that uses input coupling elements 112a, 112b, 112c, 112d, and 112e (e.g., grating couplers) to incouple light into optical waveguides present on the silicon photonics substrate. The light incoupled into the input coupling elements of the silicon photonics substrate can be incident on the input coupling elements at normal incidence or non-normal incidence (e.g., 8° off of normal incidence) as appropriate to the particular application. As will be evident to one of skill in the art, if the angle of incidence on the grating is normal, the light that is coupled into the input coupling elements will propagate in both directions in the waveguide, e.g., left and right. By utilizing a non-normal angle of incidence, embodiments of the present invention break the degeneracy, coupling the light into only a single direction (e.g., left as illustrated in the figures herein). Although an exemplary angle of 8° off of normal incidence is discussed above, this is merely exemplary and other angles of incidence, including, for example, angles in the range of 4° to 20° can be utilized by embodiments of the present invention.

Although only five input coupling elements 112a, 112b, 112c, 112d, and 112e are illustrated in FIG. 1 for purposes of clarity, it will be appreciated that the illustration of five input coupling elements is merely exemplary and other numbers of input coupling elements, less than five or greater than five can be utilized. Generally, the input coupling elements will be disposed on silicon photonics substrate 110 as a two-dimensional array extending in both the plane of the figure and into the plane of the figure.

Moreover, although a single optical waveguide represented by optical waveguide 114 is shown in the cross-section diagram of FIG. 1, it will be appreciated that multiple optical waveguides, generally one optical waveguide optically coupled to each input coupling element, as well as additional optical waveguides optically coupled to additional passive and/or active devices, as well as silicon photonics substrate output ports, will be present on the silicon photonics substrate. Similar to the layout of the input coupling elements, the optical waveguides will generally be disposed on silicon photonics substrate 110 as a two-dimensional array extending in both the plane of the figure and into the plane of the figure.

As shown in FIG. 1, a plurality of optical fibers 120 are utilized to provide multiple optical inputs, illustrated by optical fibers 122a, 122b, 122c, 122d, and 122e. Although five optical fibers are illustrated in FIG. 1, it will be appreciated that embodiments of the present invention will generally utilize a two-dimensional array of optical fibers arrayed in both the plane of the figure and into the plane of the figure. Exemplary arrays of optical fibers utilized in embodiments of the present invention include a 3×10 array, a 8×12 array, or a 16×16 array, or other array size. Thus, in some embodiments, over 100 optical fibers are utilized.

Referring to FIG. 1, optical fibers 120 are used to transport the input optical beams from the input sources (not shown), which can be either laser sources or optical gain elements. The optical fibers are attached, for example, optically bonded, fused, or welded (e.g., laser welded) onto input surface 142 of optical coupler 140. The optical fibers can be attached to the input surface using a number of optical techniques, including being optically bonded, epoxied, fused, laser welded, or the like. The monolithic attachment of the fibers to the optical coupler as illustrated in FIG. 1 provides reliability and alignment accuracy not provided by some other approaches. This monolithic attachment is particularly useful when optical fibers are attached to fiber lasers. The output of such fiber lasers (not shown) can be fusion spliced onto the optical fibers 122a-122e and, as a result, the entire optical path, from fiber laser to optical waveguide on the silicon photonics substrate can be monolithic, with the entire system, from the fiber lasers to the optical waveguide being only glass or other suitable material.

A wide variety of optical fibers can be utilized in the systems discussed herein, including single mode fibers such as SMF-28 available from Corning, Inc. of Corning, NY. In embodiments in which single mode fibers are utilized, the input coupling elements can be mode matched to the single mode optical fibers although this is not required and non-mode matched implementations are included within the scope of the present invention. A variety of input coupling elements, including grating couplers, also referred to as diffraction grating couplers, holographic optical elements, 45° etched mirrors or the like can be utilized according to embodiments of the present invention. Thus, grating couplers are merely one example of input coupling elements that can be utilized to couple light into optical waveguides present in the silicon photonics substrate and the use of grating couplers in the embodiments discussed herein does not preclude the use of other forms of input coupling elements in various embodiments of the present invention.

The optical coupler 140 utilized in the embodiment illustrated in FIG. 1 includes three surfaces: input surface 142, hypotenuse surface 144, and output surface 146. In this embodiment, hypotenuse surface 144 has optical power, i.e., hypotenuse surface 144 is curved to provide a lens function, in this case, a positive lens function that focuses an incident plane wave. As will be evident to one of skill in the art, the curvature of hypotenuse surface 144 extends in two dimensions, including both the plane of the figure and the plane orthogonal to the plane of the figure. The optical coupler 140 can be fabricated using a variety of methods including molding, polishing, etching, combinations thereof, or the like. Moreover, the angles between input surface 142, hypotenuse surface 144, and output surface 146 can be designed as appropriate to the particular application. In the illustrated embodiment, a planar surface 148 joins hypotenuse surface 144 to output surface 146, but this is not required.

Hypotenuse surface 144 can reflect light via total internal reflection (TIR) and, in these embodiments, no antireflection coating is utilized, decreasing manufacturing cost. The use of hypotenuse surface 144 to reflect light emitted by optical fibers 120 enables the optical fibers to be positioned close to silicon photonics substrate 110, for example, with a distance D of less than 10 mm, less than 5 mm, or less between optical fiber 122a farthest from silicon photonics substrate 110. Accordingly, embodiments of the present invention provide low profile structures that are compact.

Referring to FIG. 1, the optical signal emitted by optical fiber 122c propagates through input surface 142 and diverges as represented by light rays 125. After propagation to hypotenuse surface 144, light rays 125 are reflected via TIR to produce light rays 127. Due to the optical power of hypotenuse surface 144, light rays 127 converge as they propagate toward input coupling element 112c. Thus, in this embodiment, one-to-one imaging is performed, focusing light emitted by optical fiber 122c onto input coupling element 112c. In this way, the optical mode propagating in the optical fiber is matched to the optical mode incoupled by the input coupling element and, in turn, the optical waveguide.

In order to align optical coupler 140 to silicon photonics substrate 110, a variety of alignment methods and structures can be utilized. These alignment techniques and systems can enable accurate registration between the location where light from a given fiber exits optical coupler 140 and the location of the corresponding input coupling element. As an example, during fabrication of silicon photonics substrate 110, fiducials could be formed on the top surface of silicon photonics substrate 110, enabling alignment between optical coupler 140 and silicon photonics substrate 110 using optical techniques. In other embodiments, mechanical structures fabricated on silicon photonics substrate 110 can be utilized to align optical coupler 140 to silicon photonics substrate 110. For example, referring to FIG. 1, a ridge 117 extending into the plane of the figure could be formed on the top surface of silicon photonics substrate 110 in order to align optical coupler 140 in the x-direction. During assembly, optical coupler 140 could then be butted up against ridge 117 and then bonded in place, for example, using an adhesive or by laser welding. In addition to ridge 117 extending into the plane of the figure, a corresponding ridge 119 extending parallel to the plane of the figure could be used to align optical coupler in the y-direction. In some embodiments, ridge 117 and ridge 119 can be joined to form a right angle corner and a corner of optical coupler can be butted up against this right angle corner. One of ordinary skill in the art would recognize many variations, modifications, and alternatives.

Although ridge 117 and ridge 119 are illustrated in FIG. 1, continuous alignment structures are not required by embodiments of the and other alignment structures can be utilized. As an example, a pillar extending from the top surface of silicon photonics substrate 110 and positioned where ridge 117 is illustrated could be used to position optical coupler 140 accurately in the x-direction. Moreover, a series of pillars/posts arrayed in the x-direction and/or the y-direction could be utilized in a manner similar to ridge 117 and ridge 119 discussed above.

The alignment structures fabricated on the top surface of silicon photonics substrate 110 can be fabricated from a variety of materials, including silica, silicon, glass or the like. In embodiments using silica alignment structure(s), optical coupler 140 can be positioned with respect to silicon photonics substrate 110 using the silica alignment structure(s) and then laser welded in place to provide an aligned system. In some implementations, optical coupler 140 is aligned to silicon photonics substrate 110 and glass frit is placed around the base of the optical coupler before the aligned structure is heated to solidify the glass frit. One of ordinary skill in the art would recognize many variations, modifications, and alternatives.

In the exemplary be illustrated in FIG. 1, five input fibers are utilized to provide five optical inputs to optical coupler 140. The optical coupler couples the optical signal in each of the five input fibers into one of the input coupling elements, providing a one-to-one correspondence between each input fiber and each input coupling element. In turn, each input coupling element is optically coupled to one optical waveguide, thereby providing a one-to-one correspondence between each input fiber and each optical waveguide. In other embodiments, the one-to-one correspondence is not utilized and a single input fiber can provide an optical signal that is optically coupled into multiple waveguides. Additionally, to achieve a similar effect, one waveguide can be attached to a beam splitter on the silicon photonics substrate that provides, for example, a one-to-two correspondence between an optical fiber and a set of optical waveguides. One of ordinary skill in the art would recognize many variations, modifications, and alternatives.

Embodiments of the present invention provide a low-profile design in comparison with conventional approaches, which would position an optical fiber with a collimator element adjacent a grating coupler with the longitudinal axis of the optical fiber oriented normal to the grating coupler surface. In an array design, holding each of the optical fibers at a predetermined position with respect to the corresponding grating coupler, maintaining the spacing between optical fibers in the array, maintaining the desired incidence angle between the optical fibers and the grating couplers, and other mechanical and optical requirements, present many challenges. Embodiments of the present invention address these and other shortcomings present in conventional designs by permanently bonding the optical fibers to the optical element, which can, in turn, be permanently bonded to the silicon photonics substrate. Thus, embodiments of the present invention are suitable for automated assembly.

FIG. 2 is a simplified cross-section diagram illustrating a silicon photonics substrate and a plurality of input optical fibers bonded to a dual-surface optical coupler according to an embodiment of the present invention. The system illustrated in FIG. 2 shares common elements with the system illustrated in FIG. 1 and the description provided in relation to the system illustrated FIG. 1 is applicable to the system illustrated in FIG. 2 as appropriate.

Referring to FIG. 2, system 200 includes a silicon photonics substrate 210 that includes input coupling elements 212a, 212b, 212c, 212d, and 212e as well as optical waveguides represented by optical waveguide 214. Other elements, including both active and passive devices, can be provided on the silicon photonics substrate 210 as will be evident to one of skill in the art.

Although only five input coupling elements 212a, 212b, 212c, 212d, and 212e are illustrated in FIG. 2 for purposes of clarity, it will be appreciated that the illustration of five input coupling elements is merely exemplary and other numbers of input coupling elements, less than five or greater than five can be utilized. Generally, the input coupling elements will be disposed on silicon photonics substrate 210 as a two-dimensional array extending in both the plane of the figure and into the plane of the figure. Moreover, although a single optical waveguide 214 is shown in the cross-section diagram of FIG. 2, it will be appreciated that multiple optical waveguides (e.g., a two-dimensional array), generally one optical waveguide optically coupled to each input coupling element, will be present on the silicon photonics substrate.

As shown in FIG. 2, a plurality of optical fibers 220 are utilized to provide multiple optical inputs, illustrated by optical fibers 222a, 222b, 222c, 222d, and 222e. Although five optical fibers are illustrated in FIG. 2, it will be appreciated that embodiments of the present invention will generally utilize a two-dimensional array of optical fibers arrayed in both the plane of the figure and into the plane of the figure. The optical fibers are attached, for example, optically bonded, fused, or welded (e.g., laser welded) onto input surface 242 of optical coupler 240.

The optical coupler 240 utilized in the embodiment illustrated in FIG. 2 includes three surfaces: input surface 242, hypotenuse surface 244, and output surface 246. In contrast with the embodiment illustrated in FIG. 1, in which input surface 142 of optical coupler 140 is planar, both input surface 242 and hypotenuse surface 244 of optical coupler 240 have optical power, i.e., both input surface 242 and hypotenuse surface 244 of optical coupler 240 are curved to provide a lens function, in this case, a positive lens function that collimates or focuses an incident plane wave. Although the plurality of optical fibers 220 in FIG. 2 are shown to be pointing to the same location on hypotenuse surface 244, this is only one possible implementation and does not represent the generality of the concept. In general, the function of input surface 242 can be to direct the emission of each of the plurality of optical fibers to the appropriate location on hypotenuse surface 244 in order to provide the necessary coupling to the corresponding input coupling element. As will be evident to one of skill in the art, the curvature of these surfaces extends in two dimensions, including both the plane of the figure and the plane orthogonal to the plane of the figure.

In addition to providing optical power, the input surface 242 can be shaped such that the propagation axis of each optical fiber carrying the input optical beams is aligned to a single location 245 on hypotenuse surface 244 that the beams exiting from each optical fiber overlap on the hypotenuse surface. Accordingly, in some embodiments, the optical fibers are radially aligned such that beams propagating along the axis of each of the fibers impinge on the grating at location 245. It should be noted that in addition to radial alignment, the input surface 242 can be shaped such that each of the input beams propagate from the input surface 242 to location 245 such that the beams have the same size when they reach location 245.

Hypotenuse surface 244 can reflect light via total internal reflection (TIR) and, in these embodiments, no antireflection coating is utilized, decreasing manufacturing cost. The use of hypotenuse surface 244 to reflect light emitted by optical fibers 220 enables the optical fibers to be positioned close to silicon photonics substrate 210, for example, with a distance D of less than 10 mm, less than 5 mm, or less between optical fiber 222a farthest from silicon photonics substrate 210. Accordingly, embodiments of the present invention provide low profile structures that are compact.

As discussed in relation to system 100 in FIG. 1, system 200 provides for one-to-one imaging between each optical fiber and each input coupling element, for example, focusing light emitted by optical fiber 222c onto input coupling element 212c. In this way, the optical mode propagating in the optical fiber is matched to the optical mode incoupled by the input coupling element and, in turn, the optical waveguide.

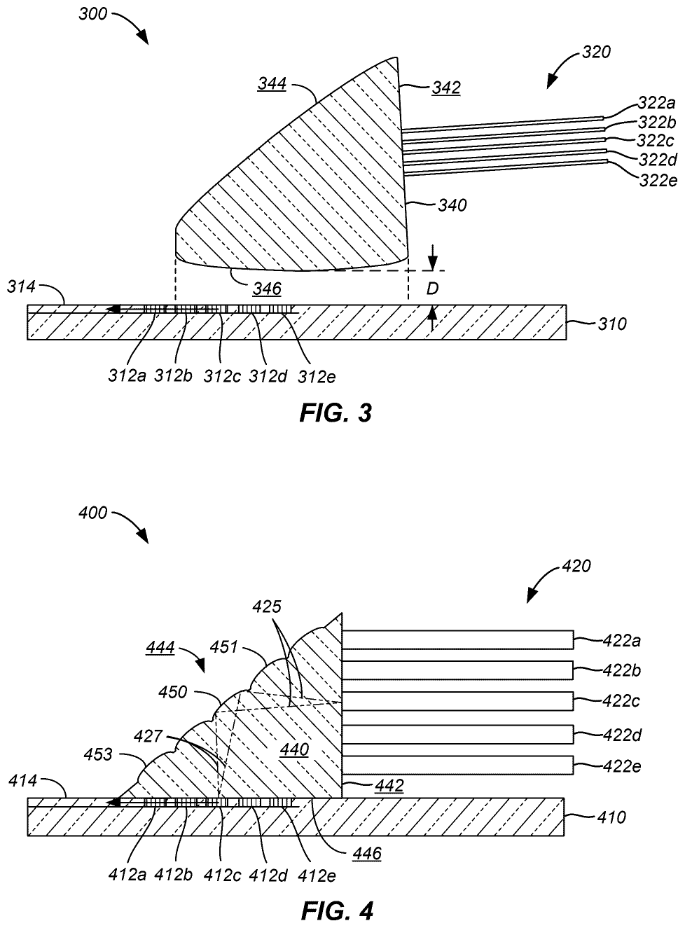

FIG. 3 is a simplified cross-section diagram illustrating a silicon photonics substrate and a plurality of input optical fibers bonded to a tri-surface optical coupler according to an embodiment of the present invention. The system illustrated in FIG. 3 shares common elements with the systems illustrated in FIGS. 1 and 2 and the description provided in relation to the systems illustrated FIGS. 1 and 2 is applicable to the system illustrated in FIG. 3 as appropriate.

Referring to FIG. 3, system 300 includes a silicon photonics substrate 310 that includes input coupling elements 312a, 312b, 312c, 312d, and 312e as well as optical waveguides represented by optical waveguide 314. Other elements, including both active and passive devices, can be provided on the silicon photonics substrate 310 as will be evident to one of skill in the art.

Although only five input coupling elements 312a, 312b, 312c, 312d, and 312e are illustrated in FIG. 3 for purposes of clarity, it will be appreciated that the illustration of five input coupling elements is merely exemplary and other numbers of input coupling elements, less than five or greater than five can be utilized. Generally, the input coupling elements will be disposed on silicon photonics substrate 310 as a two-dimensional array extending in both the plane of the figure and into the plane of the figure. Moreover, although a single optical waveguide 314 is shown in the cross-section diagram of FIG. 3, it will be appreciated that multiple optical waveguides (e.g., a two-dimensional array), generally one optical waveguide optically coupled to each input coupling element, will be present on the silicon photonics substrate.

As shown in FIG. 3, a plurality of optical fibers 320 are utilized to provide multiple optical inputs, illustrated by optical fibers 322a, 322b, 322c, 322d, and 322e. Although five optical fibers are illustrated in FIG. 3, it will be appreciated that embodiments of the present invention will generally utilize a two-dimensional array of optical fibers arrayed in both the plane of the figure and into the plane of the figure. The optical fibers are attached, for example, optically bonded, fused, or welded (e.g., laser welded) onto input surface 342 of optical coupler 340.

The optical coupler 340 utilized in the embodiment illustrated in FIG. 3 includes three surfaces: input surface 342, hypotenuse surface 344, and output surface 346. In contrast with the embodiment illustrated in FIG. 1, in which output surface 146 of optical coupler 140 is planar, both hypotenuse surface 344 and output surface 346 of optical coupler 340 have optical power, i.e., both hypotenuse surface 344 and output surface 346 of optical coupler 340 are curved to provide a lens function, in this case, a positive lens function that focuses an incident plane wave. As will be evident to one of skill in the art, the curvature of these lensed surfaces extends in two dimensions, including both the plane of the figure and the plane orthogonal to the plane of the figure.

A standoff spacer with thickness D can be utilized to provide a predetermined distance between output surface 346 of optical coupler 340 and silicon photonics substrate 310. The standoff spacer can be implemented using a single component or multiple components, depending on the particular application.

As discussed in relation to system 100 in FIG. 1, system 300 provides for one-to-one imaging between each optical fiber and each input coupling element, for example, focusing light emitted by optical fiber 322c onto input coupling element 312c. In this way, the optical mode propagating in the optical fiber is matched to the optical mode incoupled by the input coupling element and, in turn, the optical waveguide.

Moreover, in a manner similar to the system illustrated in FIG. 2, the distribution of optical power between two surfaces provides a larger optical design space for the system. In fact, in some embodiments, all three surfaces of the optical element have optical power, combining the curvature of input surface 242 shown in FIG. 2 with the curvature of hypotenuse surface 344 and output surface 346 illustrated in FIG. 3.

FIG. 4 is a simplified cross-section diagram illustrating a silicon photonics substrate and a plurality of input optical fibers bonded to an optical coupler including a microlens array according to an embodiment of the present invention. The system illustrated in FIG. 4 shares common elements with the system illustrated in FIG. 1 and the description provided in relation to the system illustrated FIG. 1 is applicable to the system illustrated in FIG. 4 as appropriate.

Referring to FIG. 4, system 400 includes a silicon photonics substrate 410 that includes input coupling elements 412a, 412b, 412c, 412d, and 412e as well as optical waveguides represented by optical waveguide 414. Other elements, including both active and passive devices, can be provided on the silicon photonics substrate 410 as will be evident to one of skill in the art.

Although only five input coupling elements 412a, 412b, 412c, 412d, and 412e are illustrated in FIG. 4 for purposes of clarity, it will be appreciated that the illustration of five input coupling elements is merely exemplary and other numbers of input coupling elements, less than five or greater than five can be utilized. Generally, the input coupling elements will be disposed on silicon photonics substrate 410 as a two-dimensional array extending in both the plane of the figure and into the plane of the figure. Moreover, although a single optical waveguide 414 is shown in the cross-section diagram of FIG. 4, it will be appreciated that multiple optical waveguides (e.g., a two-dimensional array), generally one optical waveguide optically coupled to each input coupling element, will be present on the silicon photonics substrate.

As shown in FIG. 4, a plurality of optical fibers 420 are utilized to provide multiple optical inputs, illustrated by optical fibers 422a, 422b, 422c, 422d, and 422e. Although five optical fibers are illustrated in FIG. 4, it will be appreciated that embodiments of the present invention will generally utilize a two-dimensional array of optical fibers arrayed in both the plane of the figure and into the plane of the figure. The optical fibers are attached, for example, optically bonded, fused, or welded (e.g., laser welded) onto input surface 442 of optical coupler 440.

The optical coupler 440 utilized in the embodiment illustrated in FIG. 4 includes three surfaces: input surface 442, microlens hypotenuse surface 444, and output surface 446. In this embodiment, microlens hypotenuse surface 444 includes a plurality of microlenses represented by microlens 450. In the embodiment illustrated in FIG. 4, the optical power of each microlens implements a lens function, in this case, a positive lens function that focuses an incident plane wave. As will be evident to one of skill in the art, the curvature of microlens 450 extends in two dimensions, including both the plane of the figure and the plane orthogonal to the plane of the figure. The microlens hypotenuse surface 444 can be fabricated using a variety of methods including molding, polishing, etching, combinations thereof, or the like.

Microlens hypotenuse surface 444 can reflect light via total internal reflection (TIR) and, in these embodiments, no antireflection coating is utilized, decreasing manufacturing cost. Referring to FIG. 4, the optical signal emitted by optical fiber 422c propagates through input surface 442 and diverges as represented by light rays 425. After propagation to microlens hypotenuse surface 444, light rays 125 are reflected via TIR to produce light rays 427. Due to the optical power of microlens 450, light rays 427 converge as they propagate toward input coupling element 412c. Thus, in this embodiment, one-to-one imaging is performed, focusing light emitted by optical fiber 422c onto input coupling element 412c. In this way, the optical mode propagating in the optical fiber is matched to the optical mode incoupled by the input coupling element and, in turn, the optical waveguide. In other embodiments, the imaging need not be 1:1. One of ordinary skill in the art would recognize many variations, modifications, and alternatives.

In some embodiments, each microlens can have unique optical parameters, including size, focal length, asphericity, and the like. Merely by way of example, referring once again to FIG. 4, since microlens 451 is closer to optical fiber 422a than microlens 453 is to optical fiber 422e and farther from silicon photonics substrate 410 than microlens 453 is from silicon photonics substrate 410, microlens 451 could have a longer focal length than microlens 453. Moreover, since the distance over which light diverges from optical fiber 422a to microlens 451 is less than the distance over which light diverges from optical fiber 422e to microlens 453, microlens 451 could have a smaller size than microlens 453. One of ordinary skill in the art would recognize many variations, modifications, and alternatives.

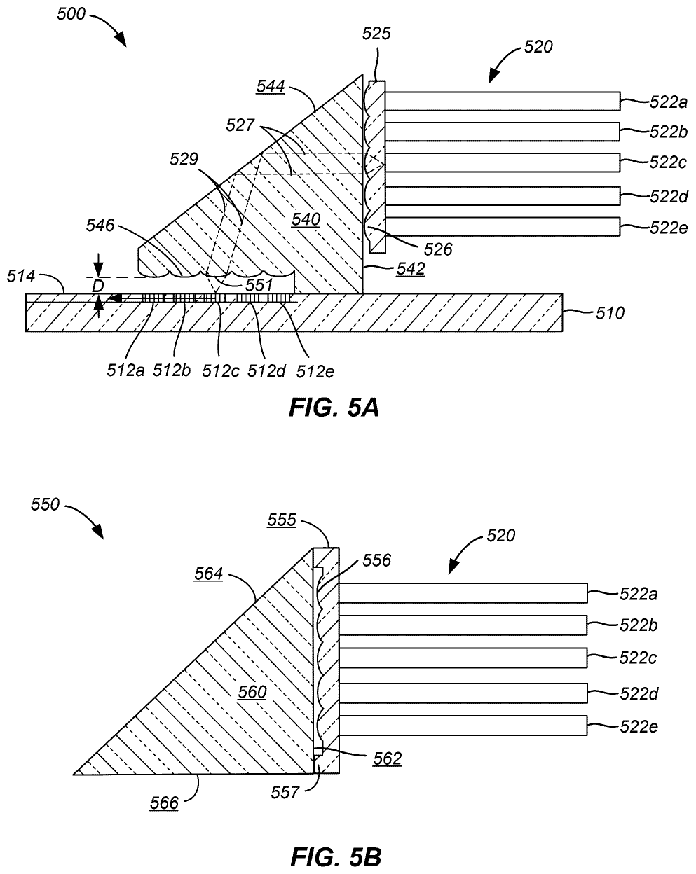

FIG. 5A is a simplified cross-section diagram illustrating a silicon photonics substrate, an optical coupler, and a fiberized microlens array according to an embodiment of the present invention. The system illustrated in FIG. 5A shares common elements with the system illustrated in FIG. 1 and the description provided in relation to the system illustrated FIG. 1 is applicable to the system illustrated in FIG. 5A as appropriate.

Referring to FIG. 5A, system 500 includes a silicon photonics substrate 510 that includes input coupling elements 512a, 512b, 512c, 512d, and 512e as well as optical waveguides represented by optical waveguide 514. Other elements, including both active and passive devices, can be provided on the silicon photonics substrate 510 as will be evident to one of skill in the art.

Although only five input coupling elements 512a, 512b, 512c, 512d, and 512e are illustrated in FIG. 5A for purposes of clarity, it will be appreciated that the illustration of five input coupling elements is merely exemplary and other numbers of input coupling elements, less than five or greater than five can be utilized. Generally, the input coupling elements will be disposed on silicon photonics substrate 510 as a two-dimensional array extending in both the plane of the figure and into the plane of the figure. Moreover, although a single optical waveguide 514 is shown in the cross-section diagram of FIG. 5A, it will be appreciated that multiple optical waveguides (e.g., a two-dimensional array), generally one optical waveguide optically coupled to each input coupling element, will be present on the silicon photonics substrate.

As shown in FIG. 5A, a plurality of optical fibers 520 are utilized to provide multiple optical inputs, illustrated by optical fibers 522a, 522b, 522c, 522d, and 522e. Although five optical fibers are illustrated in FIG. 5A, it will be appreciated that embodiments of the present invention will generally utilize a two-dimensional array of optical fibers arrayed in both the plane of the figure and into the plane of the figure. The optical fibers are attached, for example, optically bonded, fused, or welded (e.g., laser welded) onto a microlens array (MLA) 525 and the component formed by the optical fibers and the MLA can be referred to as a fiberized MLA. As shown in FIG. 5A, MLA 525 may include multiple lenslets 526. Each lenslet 526 may be referred to as a microlens. A microlens may be a small lens, generally with a diameter less than 1 mm and as small as 10 μm. Each of the lenslets 526 may be a single microlens with one planar surface and one convex (e.g., spherical) surface to refract the light. In some cases, the lenslets 526 may be or include several layers of optical material to achieve desired optical properties. In some embodiments, the MLA 525 may be formed by a one-dimensional or two-dimensional array of the lenslets 526 on a supporting substrate. Each of the lenslets 526 may serve to collimate light emitted by a corresponding optical fiber.

The optical coupler 540 utilized in the embodiment illustrated in FIG. 5A includes three surfaces: input surface 542, hypotenuse surface 544, and output surface 546. In this embodiment, input surface 542 and hypotenuse surface 544 are planar and output surface 546 includes a plurality of microlenses represented by microlens 551. A space separates output surface 546 from silicon photonics substrate 510 by a distance D. In the embodiments illustrated in FIG. 5A, the optical power of each microlens implements a lens function, in this case, a positive lens function that focuses an incident plane wave over the distance D. As will be evident to one of skill in the art, the curvature of microlens 551 extends in two dimensions, including both the plane of the figure and the plane orthogonal to the plane of the figure. The output surface 546 can be fabricated using a variety of methods including molding, polishing, etching, combinations thereof, or the like.

Referring to FIG. 5A, the optical signal emitted by optical fiber 522c propagates through a lenset of MLA 525 and is collimated as represented by light rays 527. After propagation to hypotenuse surface 544, light rays 527 are reflected via TIR to produce light rays 529. Light rays 529 are focused by microlens 551 and converge as they propagate toward input coupling element 512c. Thus, in this embodiment, one-to-one imaging is performed, focusing light emitted by optical fiber 522c onto input coupling element 512c. In this way, the optical mode propagating in the optical fiber is matched to the optical mode incoupled by the input coupling element and, in turn, the optical waveguide.

In some embodiments, the microlenses in MLA 525 may be identical to each other and each of the plurality of microlenses formed on output surface 546 can be identical to each other. In other embodiments, each of the microlenses in MLA 525 and/or each of the plurality of microlenses formed on output surface 546 can have unique optical parameters, including size, focal length, asphericity, and the like. One of ordinary skill in the art would recognize many variations, modifications, and alternatives.

In comparison to the embodiments illustrated in FIG. 4 in which optical power is provided by the microlenses present on microlens hypotenuse surface 444, the embodiment illustrated in FIG. 5A implements optical power using multiple lenslets of MLA 525 and the plurality of microlenses (represented by microlens 551) on output surface 546. Thus, two sets of collimating lenses work in conjunction with hypotenuse surface 544, which is planar, to provide for one-to-one imaging in the embodiments illustrated in FIG. 5A. Moreover, because light emitted by each optical fiber is collimated after propagation through MLA 525, the plurality of microlenses on output surface 546 can match the microlenses of MLA 525, simplifying fabrication processes.

FIG. 5B is a simplified cross-section diagram illustrating a silicon photonics substrate, an optical coupler, and a fiberized microlens array according to another embodiment of the present invention. The system illustrated in FIG. 5B shares common elements with the system illustrated in FIG. 5A and the description provided in relation to the system illustrated FIG. 5A is applicable to the system illustrated in FIG. 5B as appropriate.

Referring to FIG. 5B, system 550 includes a plurality of optical fibers 520 that are utilized to provide multiple optical inputs, illustrated by optical fibers 522a, 522b, 522c, 522d, and 522e. Although five optical fibers are illustrated in FIG. 5A, it will be appreciated that embodiments of the present invention will generally utilize a two-dimensional array of optical fibers arrayed in both the plane of the figure and into the plane of the figure. The optical fibers are attached, for example, optically bonded, fused, or welded (e.g., laser welded) onto a microlens array (MLA) 555 and the component formed by the optical fibers and the MLA can be referred to as a fiberized MLA. As shown in FIG. 5B, MLA 555 may include multiple lenslets 556, also referred to as microlenses, and MLA 555 can share common characteristics with MLA 525 illustrated in FIG. 5A. System 550 can be utilized in conjunction with a silicon photonics substrate (not shown) as discussed more fully herein.

The optical coupler 560 utilized in the embodiment illustrated in FIG. 5B is a prism with three planar surfaces. Collimated light is incident through input surface 562, reflects off of hypotenuse surface 564 by TIR, and is output through output surface 566. Output surface 566 can be mounted to a silicon photonics substrate. In order to provide a predetermined distance between MLA 555 and input surface 562, spacers 557 are positioned on the periphery of MLA 555. Spacers 557 can be butt coupled to optical coupler 560, laser welded to optical coupler 560, or the like. In some embodiments, spacers 557 are part of MLA 555, whereas in other embodiments, spacers 557 are provided as a separate component, for example, an annular structure with a rectangular shape in plan view.

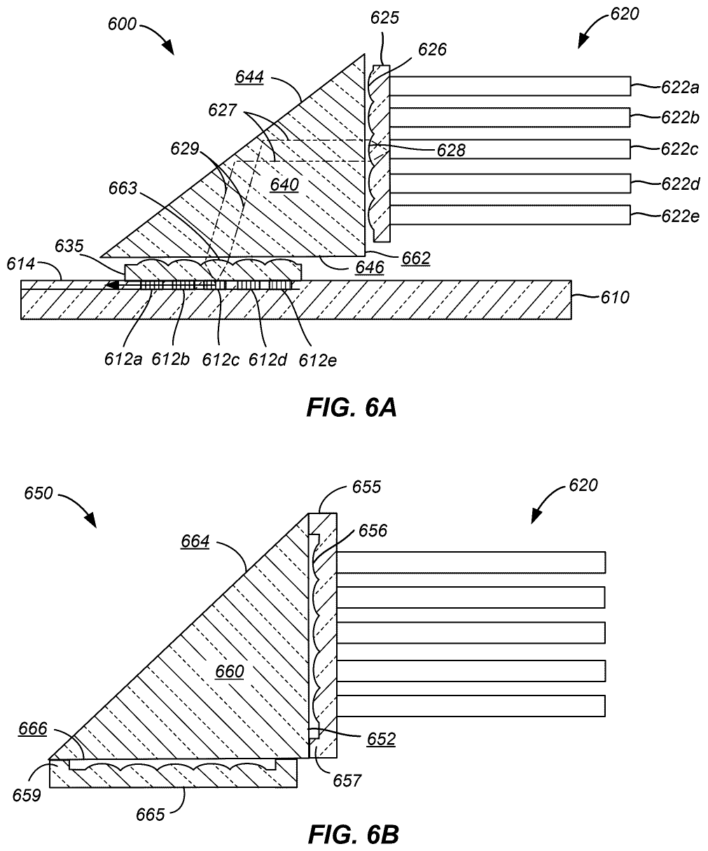

FIG. 6A is a simplified cross-section diagram illustrating a silicon photonics substrate, an optical prism, and dual microlens arrays according to an embodiment of the present invention. The system illustrated in FIG. 6A shares common elements with the system illustrated in FIG. 5A and the description provided in relation to the system illustrated FIG. 5A is applicable to the system illustrated in FIG. 6A as appropriate.

Referring to FIG. 6A, system 600 includes a silicon photonics substrate 610 that includes input coupling elements 612a, 612b, 612c, 612d, and 612e as well as optical waveguides represented by optical waveguide 614. Other elements, including both active and passive devices, can be provided on the silicon photonics substrate 610 as will be evident to one of skill in the art.

As shown in FIG. 6A, a plurality of optical fibers 620 are utilized to provide multiple optical inputs, illustrated by optical fibers 622a, 622b, 622c, 622d, and 622e. Although five optical fibers are illustrated in FIG. 6A, it will be appreciated that embodiments of the present invention will generally utilize a two-dimensional array of optical fibers arrayed in both the plane of the figure and into the plane of the figure. The optical fibers are attached, for example, optically bonded, fused, or welded (e.g., laser welded) onto a microlens array (MLA) 625 and the component formed by the optical fibers and the MLA can be referred to as a fiberized MLA. As shown in FIG. 6A, MLA 625 may include multiple lenslets 626. Each lenslet 626 may be referred to as a microlens. Each of the lenslets 626 may serve to collimate light emitted by a corresponding optical fiber.

The optical coupler 640 utilized in the embodiment illustrated in FIG. 6A is a prism with three planar surfaces: input surface 642, hypotenuse surface 644, and output surface 646. A second MLA 665 is disposed between optical coupler 640 and silicon photonics substrate 610 and provides functionality similar to that discussed above in relation to the plurality of microlenses formed on output surface 546 of optical coupler 540 illustrated in FIG. 5A. The space between output surface 646 and silicon photonics substrate 610 can be set at a predetermined distance using an appropriate spacer. One of ordinary skill in the art would recognize many variations, modifications, and alternatives.

Referring to FIG. 6A, the optical signal emitted by optical fiber 622c propagates through microlens 628 and is collimated as represented by light rays 627. After propagation to hypotenuse surface 644, light rays 627 are reflected via TIR to produce light rays 629. Light rays 629 are focused by microlens 663 and converge as they propagate toward input coupling element 612c. Thus, in this embodiment, one-to-one imaging is performed, focusing light emitted by optical fiber 622c onto input coupling element 612c. In this way, the optical mode propagating in the optical fiber is matched to the optical mode incoupled by the input coupling element and, in turn, the optical waveguide.

In some embodiments, the microlenses in MLA 625 may be identical to each other and the microlenses in MLA 635 may be identical to each other. In other embodiments, each of the microlenses in MLA 625 and/or each of the microlenses in MLA 635 can have unique optical parameters, including size, focal length, asphericity, and the like. One of ordinary skill in the art would recognize many variations, modifications, and alternatives.

FIG. 6B is a simplified cross-section diagram illustrating a silicon photonics substrate, an optical prism, and dual microlens arrays according to an embodiment of the present invention. The system illustrated in FIG. 6B shares common elements with the system illustrated in FIG. 6A and the description provided in relation to the system illustrated FIG. 6A is applicable to the system illustrated in FIG. 6B as appropriate.

Referring to FIG. 6B, system 650 includes a plurality of optical fibers 620 that are utilized to provide multiple optical inputs. The optical fibers are attached to MLA 655 and the component formed by the optical fibers and the MLA can be referred to as a fiberized MLA. As shown in FIG. 6B, MLA 655 may include multiple lenslets 656, also referred to as microlenses, and MLA 655 can share common characteristics with MLA 625 illustrated in FIG. 6A. System 650 can be utilized in conjunction with a silicon photonics substrate (not shown) as discussed more fully herein.

The optical coupler 660 utilized in the embodiment illustrated in FIG. 6B is a prism with three planar surfaces. Collimated light is incident through input surface 652, reflects off of hypotenuse surface 664 by TIR, and is output through output surface 666. In order to provide a predetermined distance between MLA 655 and input surface 662, spacers 657 are positioned on the periphery of MLA 655. Spacers 657 can be butt coupled to optical coupler 660, laser welded to optical coupler 660, or the like. In some embodiments, spacers 657 are part of MLA 655, whereas in other embodiments, spacers 657 are provided as a separate component, for example, an annular structure with a rectangular shape in plan view. Additionally, in order to provide a predetermined distance between second MLA 665 and output surface 666, spacers 659 are positioned on the periphery of second MLA 665. Spacers 659 can be butt coupled to optical coupler 660, laser welded to optical coupler 660, or the like. In some embodiments, spacers 659 are part of second MLA 665, whereas in other embodiments, spacers 659 are provided as a separate component, for example, an annular structure with a rectangular shape in plan view.

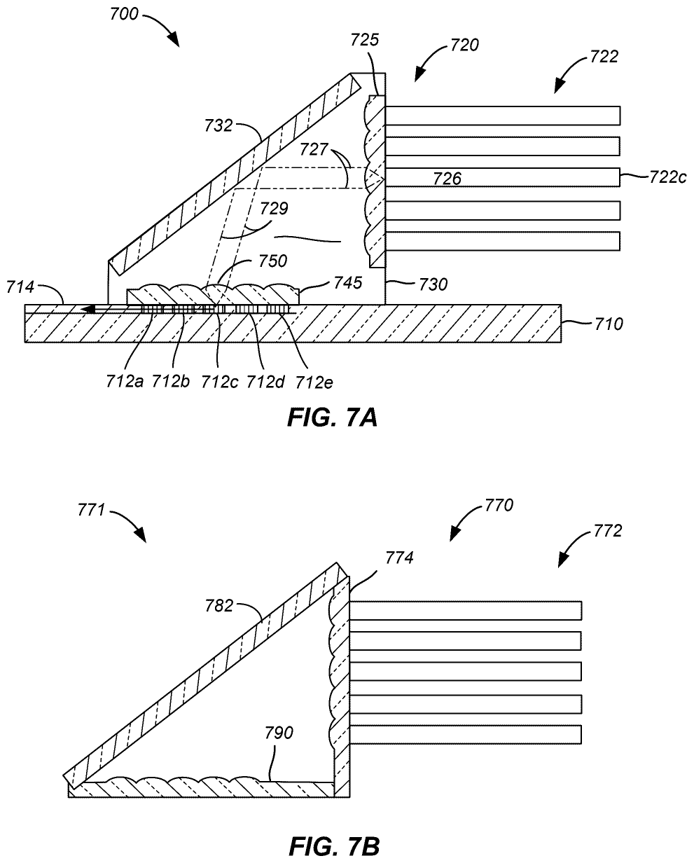

FIG. 7A is a simplified cross-section diagram illustrating a silicon photonics substrate, a plurality of input optical fibers, and dual microlens arrays mechanically coupled to a frame according to an embodiment of the present invention. Referring to FIG. 7A, system 700 includes fiberized MLA 720, which includes optical fiber 722 and MLA 725. Frame 730 supports coated flat 732. Second MLA 745 is positioned adjacent silicon photonics substrate 710 that includes input coupling elements 712a, 712b, 712c, 712d, and 712e as well as optical waveguides represented by optical waveguide 714.

Referring to FIG. 7A, the optical signal emitted by optical fiber 722c propagates through microlens 726 and is collimated as represented by light rays 727. After propagation to coated flat 732, light rays 727 are reflected to produce light rays 729. Light rays 729 are focused by microlens 750 of second MLA 745 and converge as they propagate toward input coupling element 712c. Thus, in this embodiment, one-to-one imaging is performed, focusing light emitted by optical fiber 722c onto input coupling element 712c. In this way, the optical mode propagating in the optical fiber is matched to the optical mode incoupled by the input coupling element and, in turn, the optical waveguide.

In some embodiments, the microlenses in MLA 725 may be identical to each other and each of the plurality of microlenses in second MLA 745 can be identical to each other. In other embodiments, each of the microlenses in MLA 725 and/or each of the plurality of microlenses in second MLA 745 can have unique optical parameters, including size, focal length, asphericity, and the like. One of ordinary skill in the art would recognize many variations, modifications, and alternatives.

In some embodiments, frame 730 can be machined or otherwise formed to provide a first recess into which MLA 725 is set, and/or a second recess into which coated flat 732 is set, and/or a third recess into which second MLA 745 is set. The MLAs can thus be bonded to the frame to improve stability and maintain optical performance over time. Frame 730 can be laser-weldable glass structure. In some embodiments, the frame can form a non-right angle between MLA 725 and second MLA 745, for example, to equalize the angle on coated flat 732. Although imaging is illustrated as one-to-one in FIG. 7A, this is not required and other imaging formats can be utilized. One of ordinary skill in the art would recognize many variations, modifications, and alternatives.

FIG. 7B is a simplified cross-section diagram illustrating a silicon photonics substrate, a plurality of input optical fibers, and dual microlens arrays mechanically coupled to a frame according to another embodiment of the present invention. The system 771 illustrated in FIG. 7B shares common elements with the system illustrated in FIG. 7A and the description provided in relation to the system illustrated FIG. 7A is applicable to the system illustrated in FIG. 7B as appropriate.

Referring to FIG. 7B, fiberized MLA 770 includes optical fibers 772 and MLA 774. Second MLA 745 is positioned adjacent a silicon photonics substrate (not shown). Coated flat 782 is bonded, for example, laser welded to MLA 774 and second MLA 790. Thus, in this embodiment, the laser welding of coated flat 782 to MLA 774 and second MLA 790 can provide a sealed (e.g., hermetically sealed package.

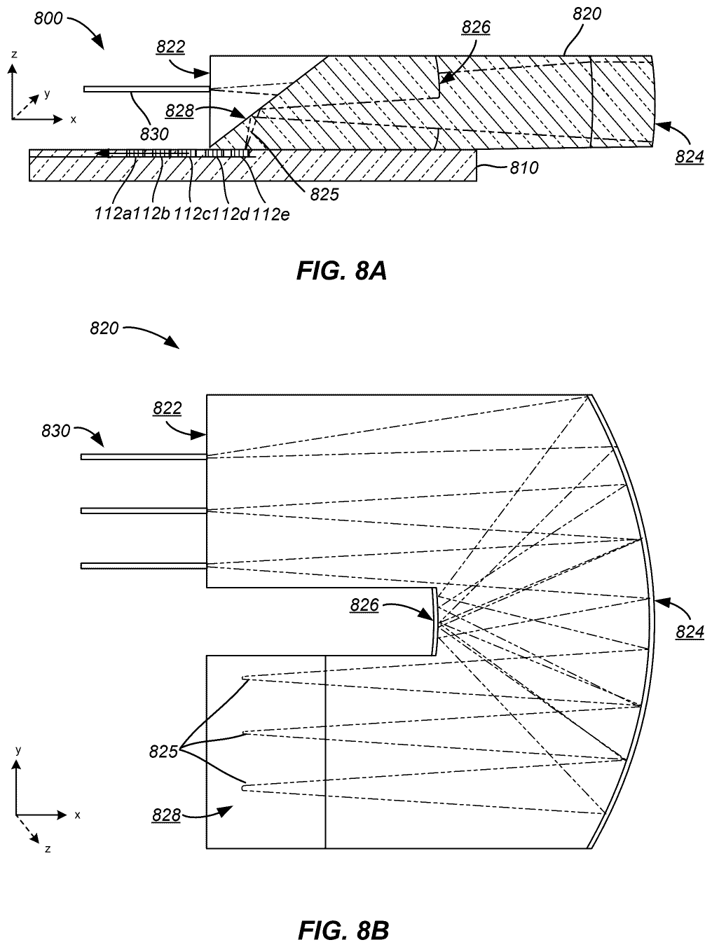

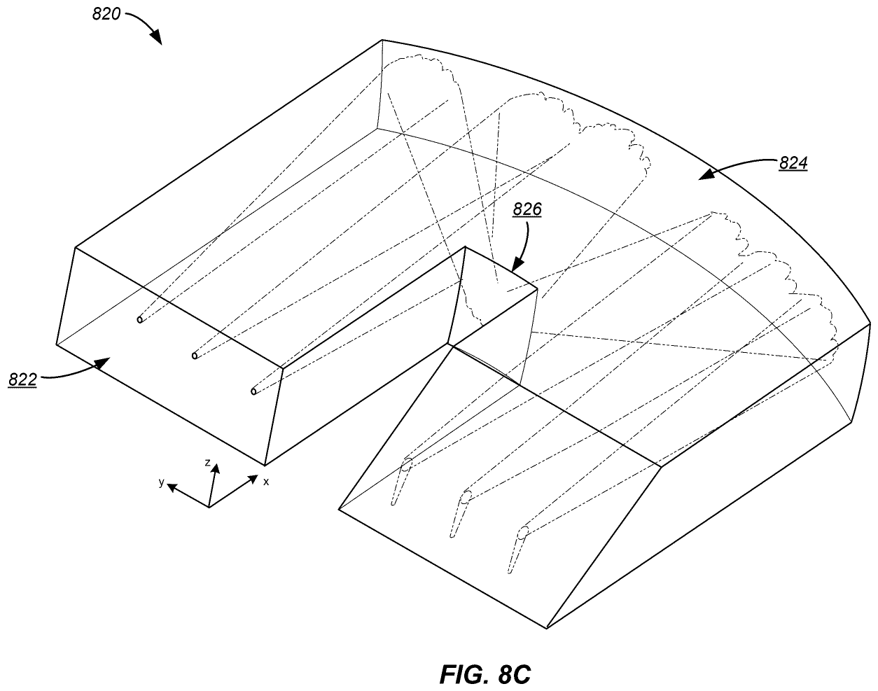

FIG. 8A is a simplified cross-section diagram illustrating a silicon photonics substrate and an Offner relay optical coupler according to an embodiment of the present invention. As illustrated in FIG. 8A, the system 800 includes optical coupler 820, also referred to as Offner relay optical coupler, is mounted on silicon photonics substrate 810, which can share common elements with silicon photonics substrate 110 illustrated in FIG. 1. Inputs to optical coupler 820 are provided by a plurality of optical fibers 830 that can be free-space coupled or mechanically coupled to input surface 822. Light from each of the plurality of optical fibers 830 diverges during propagation through optical coupler 820 and is reflected from second surface 824. In some embodiments, second surface 824 is coated with a high reflectivity (HR) coating. Second surface 824 redirects the light to third surface 826, which also be coated with an HR coating. After reflection from third surface 826, the light once again propagates through optical coupler 820 and reflects a second time off of second surface 824, which focuses the light, thereby forming converging rays 825. Output light rays exit optical coupler 820 and are incident on silicon photonics substrate 810.

Optical coupler 820 can be mounted to silicon photonics substrate 810 using a variety of bonding techniques. One of ordinary skill in the art would recognize many variations, modifications, and alternatives.

FIG. 8B is a simplified plan view diagram illustrating the silicon photonics substrate and Offner relay optical coupler shown in FIG. 8A. Referring to FIG. 8B, the plurality of optical fibers 830 provide light to input surface 822. As discussed in relation to FIG. 8A, light from each of the plurality of optical fibers 830 diverges during propagation through optical coupler 820 and is reflected from second surface 824, propagates toward third surface 826, and is reflected a second time off of second surface 824. Converging rays 825 are reflected off of fourth surface 828, which can be coated with an HR coating or reflect converging rays 825 by TIR. In the illustrated embodiment, fourth surface 828 is oriented at 52.5° to input surface 822, which is parallel to the y-z plane, and at 37.5° to the silicon photonics substrate 810, which is parallel to the x-y plane. As a result, the output light exits optical coupler 820 at an angle of 15° with respect to the negative z-direction in order to provide an angle of incidence of 15° into the incoupling elements of silicon photonics substrate 810. This is only a single example, and one skilled in the art recognizes that the angles of the surfaces and output light can be designed to match the input couplers, for example at an angle of incidence of 8°.

Thus, optical coupler 820 enables one-to-one imaging, focusing light emitted by the optical fiber 830 onto input coupling elements (not shown) present in silicon photonics substrate 810. In this way, the optical mode propagating in the optical fiber is matched to the optical mode incoupled by the input coupling element and, in turn, the optical waveguide.

FIG. 8C is a simplified perspective view diagram illustrating the silicon photonics substrate and Offner relay optical coupler shown in FIG. 8A. Input surface 822, third surface 826, and fourth surface 828 are illustrated in FIG. 8C along with the divergent and convergent rays during propagation through optical coupler 820.

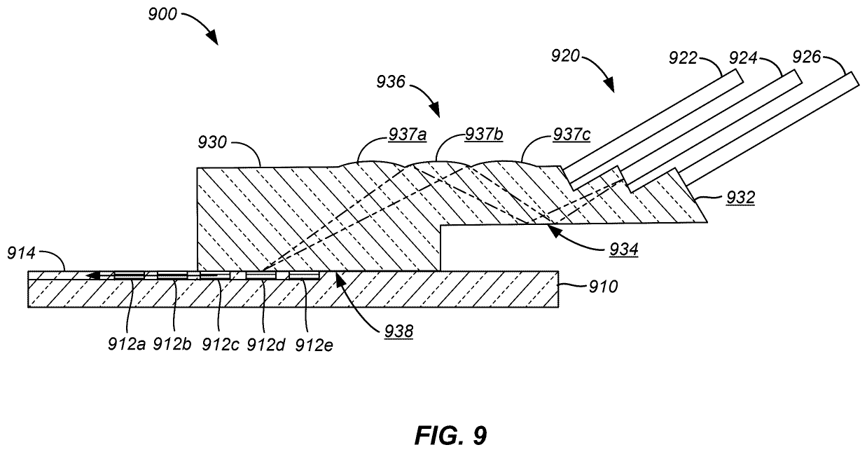

FIG. 9 is a simplified cross-section diagram illustrating a silicon photonics substrate, a plurality of input optical fibers, and an optical coupler including a microlens array according to an embodiment of the present invention. In contrast with prism-based approaches to incouple light from optical fibers into silicon photonics substrate 910, system 900 utilizes two surfaces producing TIR to reflect light during propagation through optical coupler 930.

Referring to FIG. 9, system 900 includes a silicon photonics substrate 910 that includes input coupling elements 912a, 912b, and 912c as well as optical waveguides represented by optical waveguide 914. Other elements, including both active and passive devices, can be provided on the silicon photonics substrate 910 as will be evident to one of skill in the art.

As shown in FIG. 9, a plurality of optical fibers 920 are utilized to provide multiple optical inputs, illustrated by optical fibers 922, 924, and 926. The optical fibers will generally be a two-dimensional array of optical fibers, arrayed in both the plane of the figure and into the plane of the figure.

Each of the optical fibers is attached, for example, optically bonded, fused, or welded (e.g., laser welded) onto a corresponding input surface 932 of optical coupler 930. In some embodiments, the optical fibers are laser welded in a staggered fashion. The optical coupler 930 utilized in the embodiment illustrated in FIG. 9 includes first TIR surface 934, microlens surface 936, and output surface 938. Microlens surface 936 shares common elements with microlens hypotenuse surface 444 illustrated in FIG. 4 and the discussion provided in relation to microlens hypotenuse surface 444 is applicable to microlens surface 936 as appropriate.

Microlens surface 936 includes a plurality of microlenses represented by microlens 937a, microlens 937b, and microlens 937c. The number of microlenses can correspond to the number of optical fibers in some embodiments. In the embodiments illustrated in FIG. 9, the distance between each input surface 932 and the corresponding microlens is equal, enabling the use of microlenses with identical optical properties. In other embodiments, each microlens can have unique optical parameters, including size, focal length, asphericity, and the like. In some embodiments, the microlenses can reflect light by TIR, whereas, in other embodiments, the microlenses can be coated with an HR coating or uncoated if the angle of incidence on the microlenses is high. One of ordinary skill in the art would recognize many variations, modifications, and alternatives.

In the embodiment illustrated in FIG. 9, the optical power of each microlens implements a lens function, in this case, a positive lens function that focuses the diverging light beams. The use of first TIR surface 934 and microlens surface 936 to fold the optical path can result in optical coupler 930 having a compact form factor, particularly a compact height.

As shown in FIG. 9, the angles of input surface 932, first TIR surface 934, microlens surface 936, and output surface 938 with respect to silicon photonics substrate 910 will result in a non-normal angle of incidence for light incident on input coupling elements 912a, 912b, 912c, 912d, and 912e. In other embodiments, these angles are modified to provide a normal angle of incidence. For example, in a particular embodiment, the angle of incidence on the input coupling element is between 40° and 60°, which allows for a higher density of fibers to be attached. Other angles of incidence can be utilized in other embodiments. One of ordinary skill in the art would recognize many variations, modifications, and alternatives.

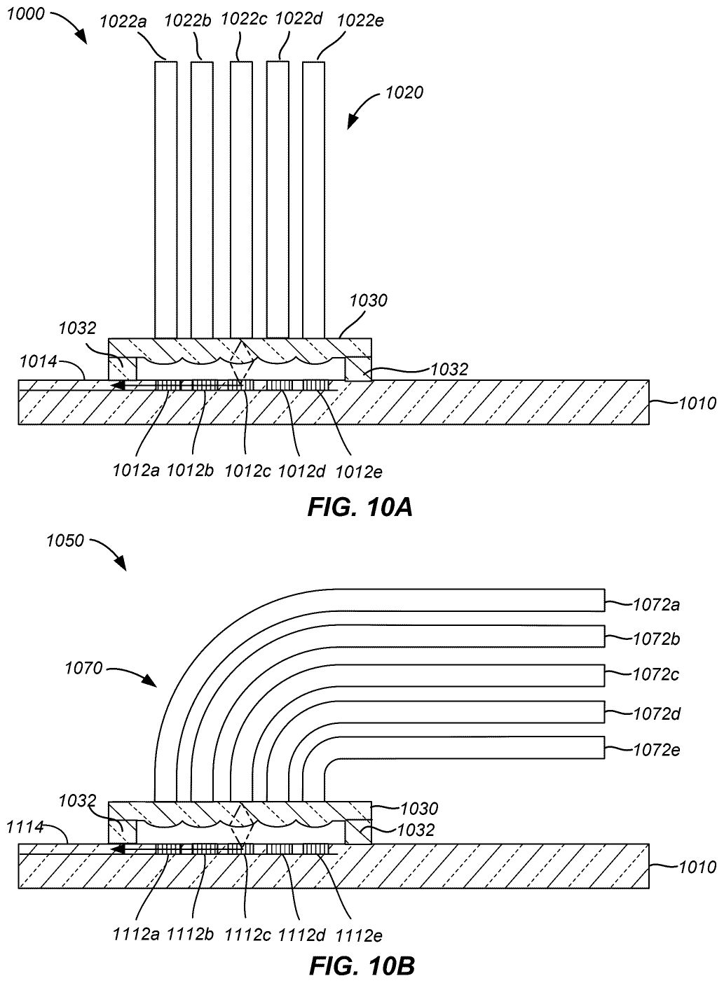

FIG. 10A is a simplified cross-section diagram illustrating a silicon photonics substrate, a plurality of input optical fibers, and a spatially separated, fiberized microlens array according to an embodiment of the present invention. Referring to FIG. 10A, system 1000 includes a silicon photonics substrate 1010 that includes input coupling elements 1012a, 1012b, 1012c, 1012d, and 1012e as well as optical waveguides represented by optical waveguide 1014.

As shown in FIG. 10A, a plurality of optical fibers 1020 are utilized to provide multiple optical inputs, illustrated by optical fibers 1022a, 1022b, 1022c, 1022d, and 1022e. The optical fibers will generally be a two-dimensional array of optical fibers, arrayed in both the plane of the figure and into the plane of the figure. Each of the optical fibers is attached, for example, optically bonded, fused, or welded (e.g., laser welded) onto MLA 1030, which is separated from silicon photonics substrate 1010 by a predetermined distance using spacers 1032 that are positioned on the periphery of MLA 1030. Spacers 1032 can be butt coupled to MLA 1030, laser welded to MLA 1030, or the like. In some embodiments, spacers 1032 are part of MLA 1030, whereas in other embodiments, spacers 1032 are provided as a separate component, for example, an annular structure with a rectangular shape in plan view. In some embodiments, spacers 1032 can be fabricated during fabrication of MLA 1030, for example, by leaving a boundary around the microlenses after etching of the microlenses. Although one-to-one imaging is illustrated in FIG. 10A, this is not required and other imaging formats can be utilized.

FIG. 10B is a simplified cross-section diagram illustrating a silicon photonics substrate, a plurality of input optical fibers, and a spatially separated, fiberized microlens array according to another embodiment of the present invention. System 1050 illustrated in FIG. 10B shares common elements with system 1000 illustrated in FIG. 10A and the description provided in relation to system 1000 illustrated FIG. 10A is applicable to system 1050 illustrated in FIG. 10B as appropriate.

Referring to FIG. 10B, optical fibers 1070 are bend-resistant fibers 1072a, 1072b, 1072c, 1072d, and 1072e that can be utilized to reduce or minimize the height profile of system 1050.

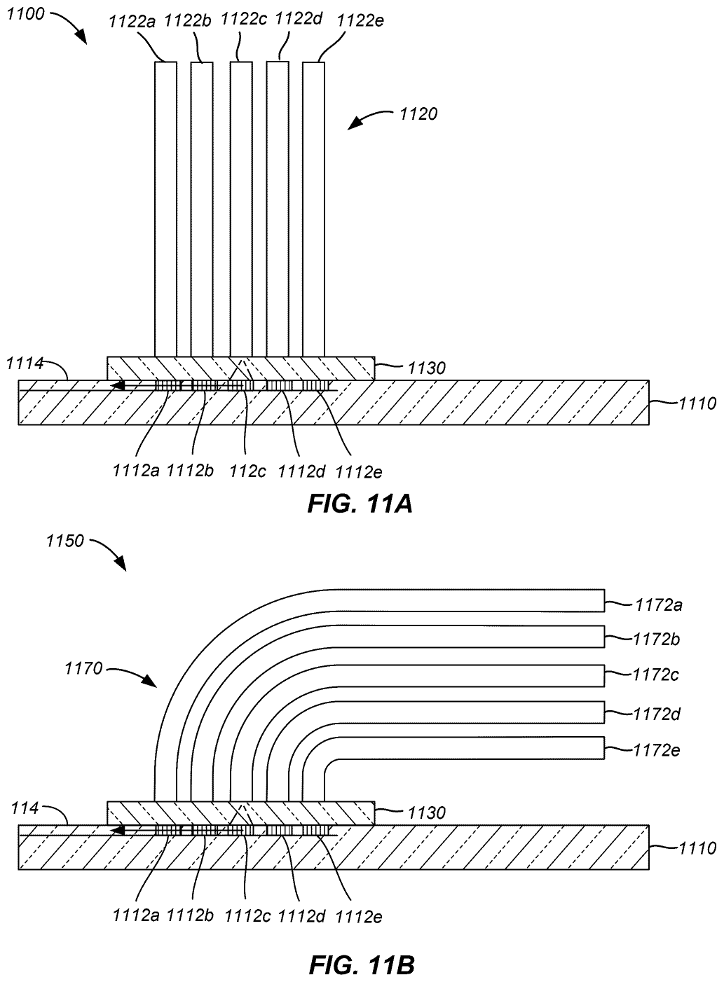

FIG. 11A is a simplified cross-section diagram illustrating a silicon photonics substrate, a plurality of input optical fibers, and a fiberized optical coupler according to an embodiment of the present invention. Referring to FIG. 11A, system 1100 includes a silicon photonics substrate 1110 that includes input coupling elements 1112a, 1112b, 1112c, 1112d, and 1112e as well as optical waveguides represented by optical waveguide 1114.

As shown in FIG. 11A, a plurality of optical fibers 1120 are utilized to provide multiple optical inputs, illustrated by optical fibers 1122a, 1122b, 1122c, 1122d, and 1122e. The optical fibers will generally be a two-dimensional array of optical fibers, arrayed in both the plane of the figure and into the plane of the figure. Each of the optical fibers is attached, for example, optically bonded, fused, or welded (e.g., laser welded) onto plate 1130, which is, in turn, attached to silicon photonics substrate 1110. In other embodiments, one or more spacers are utilized to separate plate 1130 from silicon photonics substrate 1110.

In the embodiment illustrated in FIG. 11A, each of the input coupling elements is designed to accept a diverging light beam output from a corresponding optical fiber.

FIG. 11B is a simplified cross-section diagram illustrating a silicon photonics substrate, a plurality of input optical fibers, and a fiberized optical coupler according to another embodiment of the present invention. System 1150 illustrated in FIG. 11B shares common elements with system 1100 illustrated in FIG. 11A and the description provided in relation to system 1100 illustrated FIG. 11A is applicable to system 1150 illustrated in FIG. 11B as appropriate.

Referring to FIG. 11B, optical fibers 1170 are bend-resistant fibers 1172a, 1172b, 1172c, 1172d, and 1172e that can be utilized to reduce or minimize the height profile.

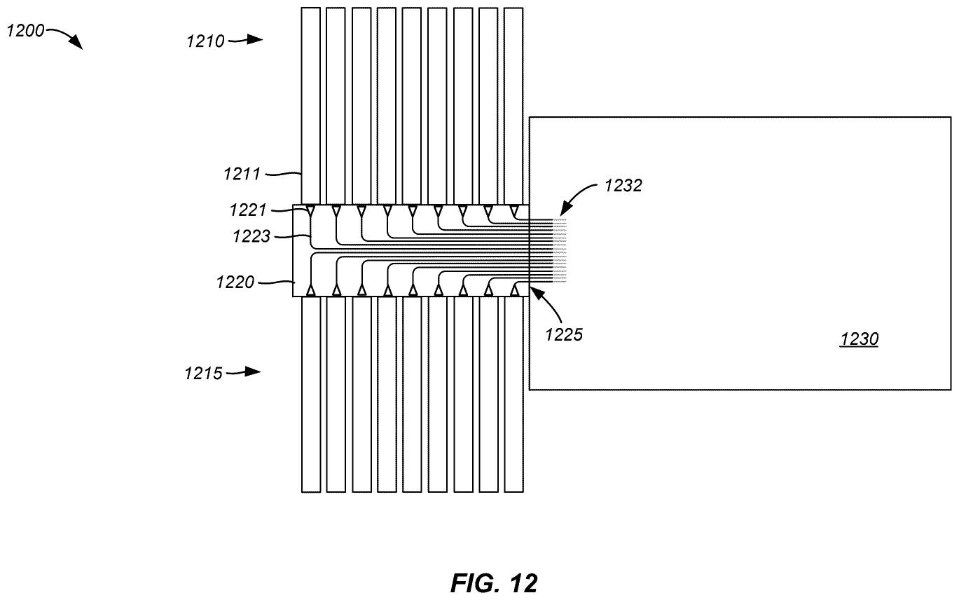

FIG. 12 is a simplified plan view diagram illustrating a silicon photonics substrate, a plurality of input optical fibers, and a high density optical coupler according to an embodiment of the present invention. As illustrated in FIG. 12, system 1200 includes two sets of input optical fibers, first set of fibers 1210 and second set of fibers 1215, each of which are optically coupled to high density optical coupler 1220. In some embodiments, each of the optical fibers in first set of fibers 1210 and second set of fibers 1215 is laser welded at a predetermined location on high density optical coupler 1220.

High density optical coupler 1220 can be a glass optical element or asilicon optical element depending on the particular application. A plurality of mode field adapters (MFAs) are integrated into high density optical coupler 1220. As a result, input light transmitted through an optical fiber, for example, input optical fiber 1211, is input in mode field adapter (MFA) 1221 and propagates in waveguide 1223. Similarly, light from other input optical fibers is input into other MFAs prior to propagation in other waveguides. As shown in FIG. 12, the waveguides present in high density optical coupler 1220 can be designed to provide an array of waveguides at output surface 1225 of high density optical coupler 1220. The array of waveguides at output surface 1225 of high density optical coupler 1220 are optical coupled to a corresponding array of waveguides 1232 present on silicon photonics device 1230.

Thus, in the embodiment illustrated in FIG. 12, edge coupling into silicon photonics device 1230 is utilized rather than surface coupling as discussed in other embodiments. Since the optical fiber mode is converted to a waveguide mode off of the silicon photonics device, the real estate of the silicon photonics device can be utilized more efficiently as appropriate to the small size of silicon photonics device waveguides. It should be noted that scaling of system 1200 is generally only limited by the silicon photonics device waveguide density, not the diameter of the input optical fibers. One of ordinary skill in the art would recognize many variations, modifications, and alternatives.

Various examples of the present disclosure are provided below. As used below, any reference to a series of examples is to be understood as a reference to each of those examples disjunctively (e.g., “Examples 1-4” is to be understood as “Examples 1, 2, 3, or 4”).

Example 1 is a system comprising: a plurality of optical fibers; a first microlens array including a plurality of microlenses, wherein each of the plurality of optical fibers is bonded to one of the plurality of microlenses; a prism disposed adjacent the first microlens array; a second microlens array disposed adjacent the prism; and a silicon photonics substrate disposed adjacent the second microlens array and including a plurality of input coupling elements and one or more optical waveguides.

Example 2 is the system of example 1 wherein the plurality of input coupling elements comprise a plurality of grating couplers.

Example 3 is the system of example(s) 1-2 wherein each of the one or more optical waveguides is optically coupled to one of the plurality of input coupling elements.

Example 4 is the system of example(s) 1-3 wherein the first microlens array is bonded to an input surface of the prism.

Example 5 is the system of example(s) 1-4 wherein the first microlens array further comprising a spacer configured to separate the first microlens array from the input surface of the prism by a predetermined distance.

Example 6 is the system of example(s) 1-5 wherein the second microlens array is bonded to an output surface of the prism.

Example 7 is the system of example(s) 1-6 wherein the second microlens array further comprising a spacer configured to separate the second microlens array from the output surface of the prism by a predetermined distance.

Example 8 is the system of example(s) 1-7 wherein: the microlenses in the first microlens array are configured to collimate input light emitted by the plurality of optical fibers to produce a set of collimated beams; the prism is configured to reflect the set of collimated beams via total internal reflection; and the microlenses in the second microlens array are configured to focus the set of collimated beams to produce a set of converging beams incident on the plurality of input coupling elements.

Example 9 is the system of example(s) 1-8 wherein the set of converging beams are incident on the plurality of input coupling elements at a non-normal angle of incidence.

Example 10 is the system of example(s) 1-9 wherein the non-normal angle of incidence ranges from 4° to 20°, for example, 8°.

Example 11 is the system of example(s) 1-10 further comprising an alignment structure disposed on a surface of the silicon photonics substrate.

Example 12 is the system of example(s) 1-11 wherein the alignment structure comprises one or more ridges.

Example 13 is the system of example(s) 1-12 wherein the alignment structure comprises one or more pillars.

Example 14 is a system, comprising: a plurality of optical fibers; a plurality of grating couplers; one or more waveguides coupled to the plurality of grating couplers; and an optical element coupled to the plurality of optical fibers and to the plurality of grating couplers.

Example 15 is the system of example 14, wherein the optical element comprises a prism configured to image light from each of the plurality of optical fibers onto a corresponding grating coupler of the plurality of grating couplers.

Example 16 is the system of example(s) 14-15, wherein the plurality of optical fibers are welded to a surface of the optical element.

Example 17 is the system of example(s) 14-16, wherein each of the one or more waveguides corresponds to one of the plurality of optical fibers and one of the plurality of grating couplers.

Example 18 is the system of example(s) 14-17, wherein the optical element comprises a plurality of curved surfaces and a planar surface.

Example 19 is the system of example(s) 14-18, wherein the plurality of optical fibers are welded to a curved surface of the plurality of curved surfaces of the optical element.

Example 20 is the system of example(s) 14-19, wherein the plurality of optical fibers are welded to the planar surface.

Example 21. The system of example(s) 14-20, wherein the optical element is coupled to the plurality of grating couplers at the planar surface.

Example 22 is the system of example(s) 14-21, further comprising a standoff spacer, wherein the optical element is (i) optically coupled to the plurality of grating couplers and (ii) spaced apart from the plurality of grating couplers via the standoff spacer at a curved surface of the plurality of curved surfaces.

Example 23 is the system of example(s) 14-22, wherein at least one surface of the optical element comprises a microlens array.

Example 24 is the system of example(s) 14-23, wherein the plurality of optical fibers are coupled to the optical element at a first surface adjacent to the at least one surface comprising the microlens array, and wherein the plurality of grating couplers are coupled to the optical element at a second surface adjacent to the at least one surface comprising the microlens array.

Example 25 is the system of example(s) 14-24, further comprising a fiberized microlens array coupled to a first surface of the optical element, wherein the plurality of optical fibers are coupled to the optical element with the fiberized microlens array at the first surface.

Example 26 is the system of example(s) 14-25, wherein a second surface of the optical element comprises a microlens array, and wherein the optical element is coupled to the grating couplers at the second surface.

Example 27 is the system of example(s) 14-26, further comprising: a first microlens array coupled to a first surface of the optical element; and a second microlens array coupled to a second surface of the optical element, wherein the plurality of optical fibers are coupled to the optical element via the first microlens array at the first surface, and wherein the plurality of grating couplers are coupled to the optical element via the second microlens array at the second surface.

Example 28 is the system of example(s) 14-27, wherein the optical element comprises a first microlens array, a second microlens array, an optical flat, and a frame connected to the first microlens array, the second microlens array, and the optical flat, wherein the frame is configured to position the optical flat adjacent to the first microlens array and the second microlens array.

Example 29 is the system of example(s) 14-28, wherein the plurality of optical fibers are coupled to the optical element via the first microlens array, and wherein the plurality of grating couplers are coupled to the optical element via the second microlens array.

Example 30 is the system of example(s) 14-29, wherein the optical element comprises an Offner relay including an incoupling surface, an outcoupling surface, a notch separating the incoupling surface and the outcoupling surface, a first highly reflective surface opposite the incoupling surface and the outcoupling surface, and a second highly reflective surface at the notch, wherein the plurality of optical fibers are coupled to the optical element at the incoupling surface, and wherein the plurality of grating couplers are coupled to the optical element at the outcoupling surface.

Example 31 is the system of example(s) 14-30, wherein a first surface of the optical element comprises a microlens array, and wherein a second surface of the optical element opposite the first surface is configured to reflect light from plurality of optical fibers by total internal reflection.

Example 32 is the system of example(s) 14-31, wherein each optical fiber of the plurality of optical fibers is welded to a corresponding incoupling surface of the optical element in a staggered pattern.

Example 33 is the system of example(s) 14-32, wherein the plurality of optical fibers is welded to a third surface of the optical element, the third surface adjacent to the first surface and the second surface.

Example 34 is the system of example(s) 14-33, wherein the optical element comprises a microlens array including a first surface and a second surface opposite the first surface, wherein the plurality of optical fibers are coupled to the first surface, and wherein the plurality of grating couplers are coupled to the second surface.

Example 35 is the system of example(s) 14-34, further comprising a standoff spacer, wherein the optical element is (i) optically coupled to the plurality of grating couplers and (ii) spaced apart from the plurality of grating couplers via the standoff spacer at the second surface of the microlens array.

Example 36 is the system of example(s) 14-35, wherein the standoff spacer is formed from a portion of the microlens array.

Example 37 is the system of example(s) 14-36, wherein the plurality of optical fibers comprises bend resistant optical fibers.

Example 38 is the system of example(s) 14-37, wherein the optical element comprises an optical plate including a first surface and a second surface opposite the first surface, wherein the plurality of optical fibers are coupled to the first surface, and wherein the plurality of grating couplers are coupled to the second surface.

Example 39 is the system of example(s) 14-38, wherein the optical element comprises a plurality of mode field adapters and a plurality of optical element waveguides, each mode field adapter coupled to a corresponding optical element waveguide at a first end of the optical element waveguide, wherein each optical fiber of the plurality of optical fibers is coupled to a mode field adapter of the plurality of mode field adapters, and wherein each grating coupler of the plurality of grating couplers is coupled to a second end of each optical element waveguide of the plurality of optical element waveguides.

Example 40 is the system of example(s) 14-39, wherein a first portion of the plurality of mode field adapters is disposed at a first surface of the optical element, and wherein a second portion of the plurality of mode field adapters is disposed at a second surface of the optical element opposite the first surface.

Example 41 is the system of example(s) 14-40, wherein the second end of each optical element waveguide is disposed at a third surface of the optical element adjacent the first surface and the second surface.

Example 42 is a method of manufacturing any of the systems of example(s) 14-41.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A system comprising:
a plurality of optical fibers;
a first microlens array including a plurality of microlenses, wherein each of the plurality of optical fibers is bonded to one of the plurality of microlenses;
a prism disposed adjacent the first microlens array;
a second microlens array disposed adjacent the prism; and
a silicon photonics substrate disposed adjacent the second microlens array and including a plurality of input coupling elements and one or more optical waveguides.

2. The system of claim 1 wherein the plurality of input coupling elements comprise a plurality of grating couplers.

3. The system of claim 1 wherein each of the one or more optical waveguides is optically coupled to one of the plurality of input coupling elements.

4. The system of claim 1 wherein the first microlens array is bonded to an input surface of the prism.

5. The system of claim 4 wherein the first microlens array further comprising a spacer configured to separate the first microlens array from the input surface of the prism by a predetermined distance.

6. The system of claim 1 wherein the second microlens array is bonded to an output surface of the prism.

7. The system of claim 6 wherein the second microlens array further comprising a spacer configured to separate the second microlens array from the output surface of the prism by a predetermined distance.

8. The system of claim 1 wherein:
the microlenses in the first microlens array are configured to collimate input light emitted by the plurality of optical fibers to produce a set of collimated beams;
the prism is configured to reflect the set of collimated beams via total internal reflection; and
the microlenses in the second microlens array are configured to focus the set of collimated beams to produce a set of converging beams incident on the plurality of input coupling elements.

9. The system of claim 8 wherein the set of converging beams are incident on the plurality of input coupling elements at a non-normal angle of incidence.

10. The system of claim 9 wherein the non-normal angle of incidence ranges from 4° to 20°.

11. The system of claim 10 wherein the non-normal angle of incidence is 8°.

12. The system of claim 1 further comprising an alignment structure disposed on a surface of the silicon photonics substrate.

13. The system of claim 12 wherein the alignment structure comprises one or more ridges.

14. The system of claim 13 wherein the alignment structure comprises one or more pillars.
